(19) United States
(12) Patent Application Publication
(10) Pub. No.: US 2020/0355218 A1
(43) Pub. Date: Nov. 12, 2020

(54) TILTING PAD BEARING DEVICE AND ROTATING MACHINE

(71) Applicant: Hitachi Industrial Products, Ltd., Tokyo (JP)

(72) Inventors: Motoki SATO, Tokyo (JP); Makoto HEMMI, Tokyo (JP); Naohiko TAKAHASHI, Tokyo (JP)

(21) Appl. No.: 16/766,341

(22) PCT Filed: Aug. 22, 2018
(86) PCT No.: PCT/JP2018/030984

§ 371 Date: May 22, 2020

(30) Foreign Application Priority Data
Jan. 16, 2018 (JP) 2018-004635

(51) Int. Cl. F16C 17/03; F16C 33/10

(52) U.S. Cl. CPC F16C 17/03; F16C 33/10

(57) ABSTRACT

A tilting pad bearing device of the present invention is as follows: in a tilting pad bearing device including plural tilting pads (2), each of which is swingably disposed on the inside of a bearing housing (4) via a pivot and supports a rotary shaft, a cooling flow path which is a circumferentially communicating path is disposed in a tiling pad and an arrangement is made so that an axial directional position of the cooling flow path inlet is not coincident with an axial directional position of an oil feeding hole (7) for feeding oil to a space between tiling pads. As the cooling flow path, for example, a cooling groove (12) which is a circumferentially communicating groove is disposed in a side face of a tilting pad 2 in an axial direction.

### TECHNICAL FIELD

The present invention relates to a tilting pad bearing device and a rotating machine.

### BACKGROUND ART

In recent years, for large rotating machines for industrial use, it is demanded to increase the peripheral speed of bearing parts along with cost reduction. In these machines, sliding bearings that support a load via a thin fluid film are mainly used. As compared with rolling bearings, the sliding bearings have higher load bearing performance and better vibration damping. In addition, in a machine like a centrifugal compressor, tilting pad bearings having particularly good vibration stability among the sliding bearings are used, since they are frequently used under conditions of low loads and high rotating speed.

A tilting pad bearing is comprised of a bearing housing, plural pivots arranged inside the housing, and plural tilting pads which are supported via the pivots. When lubricant oil is supplied between the pads and a rotary shaft, pressure is generated inside oil films, thereby enabling it to support the rotary shaft. In addition, the pads are swingable on the pivots and their tilt changes depending on a distribution of pressure in the oil film, so that it is possible to restrain unstable vibration such as an oil whip.

However, inside the oil films, pressure is generated and, at the same time, heat is generated by shear friction. Some of the oil with increased temperature passes as it is out of the bearing, but the remaining oil transfers heat to the pads and the housing and, consequently, their temperature increases at the same time. Because the sliding surfaces of the pads have a cast metal layer having a low melting point, it is necessary to keep the pad temperature lower than a melting temperature; to do so, an appropriate quantity of lubricant oil must be supplied.

There are two ways of supplying lubricant oil to a tilting pad bearing. That is, one is direct lubrication that supplies lubricant oil to the sliding surfaces through oil feeding holes formed in the respective pad or oil feeding nozzles disposed between adjacent tilting pads and the other is oil bath lubrication that has lubricant oil stored inside the bearing housing by sealings arranged in place along an axial direction and supplies the oil to the sliding surfaces.

In the case of oil bath lubrication, even in the event that it has become hard to supply oil because of failure of an oil feed pump or the like, it is possible to maintain lubrication with oil inside an oil bath until stop of the shaft revolution and reliability is high. Nevertheless, the interior of the bearing housing is required to be filled with lubricant oil at all times and, therefore, an agitation loss is large and the oil feed amount to cool the temperature inside the oil bath increases. In addition, along with an increase in the peripheral speed of the bearing, the agitation loss further increases and, consequently, more oil is needed. To augment the oil feed amount, it is necessary to expand the capacity of an auxiliary such as a pump and cost is likely to rise. Therefore, it becomes a problem to suppress a rise in the bearing temperature without changing the oil feed amount.

With the aim of decreasing the surface temperature of tilting pads and the oil film temperature, thus reducing the lubricant oil amount and reducing the agitation loss, a tilting pad type journal bearing with plural cooling flow paths formed in the tilting pads, penetrating the interior of the pads in a circumferential direction, is proposed (PTL 1).

### CITATION LIST

### Patent Literature

PTL 1: Japanese Patent Application Laid-Open No. 2009-063015

### SUMMARY OF INVENTION

### Technical Problem

In the case of oil bath lubrication, oil supplied to the interior of the bearing housing swirls in a space between pads and decreases the oil temperature in the space. The thus cooled oil is further supplied to the sliding surfaces.

According to an examination made by the present inventors, it is impossible to sufficiently cool oil in inter-pad spaces in the tilting pad type journal bearing described in PTL 1 and there is a possibility that the temperature of the sliding surfaces of the bearing cannot be decreased sufficiently even though the pad temperature can be decreased by the cooling flow paths.

An object of the present invention resides in providing a tilting pad bearing device and a rotating machine, allowing a decrease in both the temperature of oil in an inter-pad space and the pad temperature and capable of suppressing a rise in the temperature of the sliding surfaces of the bearing even at high rotating speed.

### Solution to Problem

The present invention is characterized in that a cooling flow path which is a circumferentially communicating path is disposed in a tiling pad and an arrangement is made so that an axial directional position of the cooling flow path inlet is not coincident with an axial directional position of an oil feeding hole for feeding oil to a space between tilting pads.

### Advantageous Effects of Invention

According to the present invention, it is possible to allow a decrease in both the temperature of oil in the inter-pad space and the pad temperature and suppress a rise in the temperature of the sliding surfaces of the bearing even at high rotating speed.

Problems, configurations, and advantageous effects other than described above will be made apparent from the following description of embodiments.

### BRIEF DESCRIPTION OF DRAWINGS

FIG. 1 is a transverse sectional view of a tilting pad bearing device.

FIG. 2 is a longitudinal sectional view of the tilting pad bearing device.

FIG. 3 is a perspective view of a tilting pad.

FIG. 4 is a perspective view of a tilting pad in a first example of embodiments of the present invention.

FIG. 5 is a perspective view of a tilting pad in a second example of embodiments of the present invention.

FIG. 6 is a perspective view of a tilting pad in a third example of embodiments of the present invention.

FIG. 7 is a diagram depicting an example of a structure of a centrifugal compressor to which a tilting pad bearing device of the present invention is applied.

### DESCRIPTION OF EMBODIMENTS

In the following, examples of embodiments of the present invention will be described with the aid of the drawings.

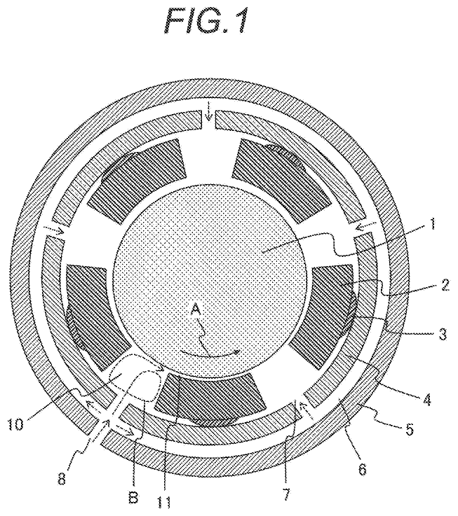

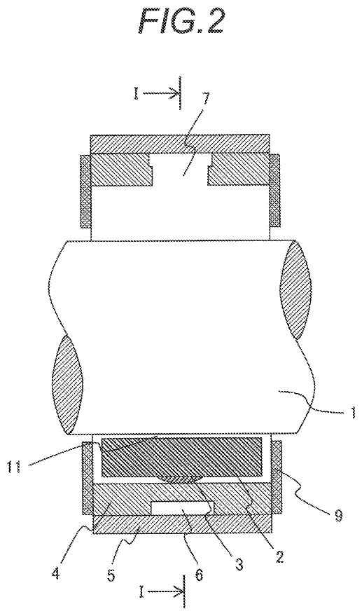

First, an example of a structure of a tilting pad bearing device to which the present invention is applied is described with reference to FIG. 1 and FIG. 2. Additionally, the structure of the tilting pad bearing device is not limited to this.

FIG. 1 is a transverse sectional view of the tilting pad bearing device (the cross-sectional view taken along the arrow line I-I in FIG. 2). FIG. 2 is a longitudinal sectional view of the tilting pad bearing device.

The bearing depicted in FIG. 1 and FIG. 2 is an oil bath lubricated journal bearing which supports the axial load of a rotary shaft 1. As depicted in FIG. 1, the tilting pad bearing includes plural tilting pads 2, plural pivots 3, a bearing housing 4, and a bearing casing 5. The plural tilting pads 2 are arranged in place in a circumference direction of the rotary shaft 1 to face the outer peripheral surface of the rotary shaft 1. The bearing housing 4 supports the plural tilting pads 2 in a tiltable (swingable) manner via the plural pivots 3. The bearing casing 5 holds the bearing housing 4 with its inner periphery contacting the outer periphery of the housing, as depicted in FIG. 2.

An oil guide groove 6 which is a circumferentially communicating groove is disposed on the outer peripheral surface of the bearing housing 4, and plural oil feeding holes 7 are disposed opening toward a radially inward direction from the oil guide groove 6. Also, in the bearing casing 5, an oil guide hole 8 communicating with the oil guide groove 6 is disposed opening toward a radially inward direction. Lubricant oil is supplied through the oil guide hole 8, flows through the oil guide groove 6, and flows into the interior of the bearing (spaces between adjacent tilting pads in a circumferential direction: inter-pad spaces 10) through the oil feeding holes 7.

As depicted in FIG. 2, sealings 9 are provided laterally on both sides of the bearing housing 4 in an axial direction. The sealings 9 are formed of an annular member. Having flowed into the interior of the bearing, lubricant oil is stored inside the bearing by the sealings 9 and the interior of the bearing is filled with the lubricant oil, i.e., placed in an oil bath state. Then, as much of the lubricant oil as a quantity of oil supplied through the oil guide hole 8 is discharged through clearances between the rotary shaft 1 and the sealings 9. Generally, the clearances between the rotary shaft 1 and the sealings 9 are designed to be larger than the clearances between the rotary shaft 1 and the tilting pads 2.

When the rotary shaft 1 rotates in a rotating direction A indicated in FIG. 1, lubricant oil having flowed into the interior of the bearing through the oil feeding holes 7 once goes through the inter-pad spaces 10 and is supplied to sliding surfaces 11 existing between the rotary shaft 1 and the tilting pads 2. Then, thin fluid films are formed on the sliding surfaces 11 and pressure is generated inside the oil films, thereby enabling it to support the rotary shaft 1. However, because heat is generated by shear friction inside the fluid films, there is a rise in the stored lubricant oil and the entire bearing.

Then, background to development of the present invention is described.

In the tilting pad type journal bearing described in PTL 1, plural cooling flow paths are formed in the tilting pads, penetrating the interior of the pads in a circumferential direction, for aiming at decreasing the surface temperature of the tilting pads and the oil film temperature by cooling the tilting pads. However, in the tilting pad type journal bearing described in PTL 1, although an effect of cooling the pads can be expected, because the inlet of the cooling flow paths is located in the central portion of a pad, oil supplied to the interior of the bearing housing (the inter-pad spaces) flows into the cooling flow paths without swirling in the inter-pad spaces. In this consequence, oil in the inter-pad spaces cannot be cooled enough, and there is a rise in the temperature of oil that is supplied from the inter-pad spaces to the sliding surfaces of the bearing. According to the examination made by the present inventors, when oil in the inter-pad spaces cannot be cooled enough, there is a possibility that the temperature of the sliding surfaces of the bearing cannot be decreased sufficiently even though the pad temperature can be decreased by the cooling flow paths.

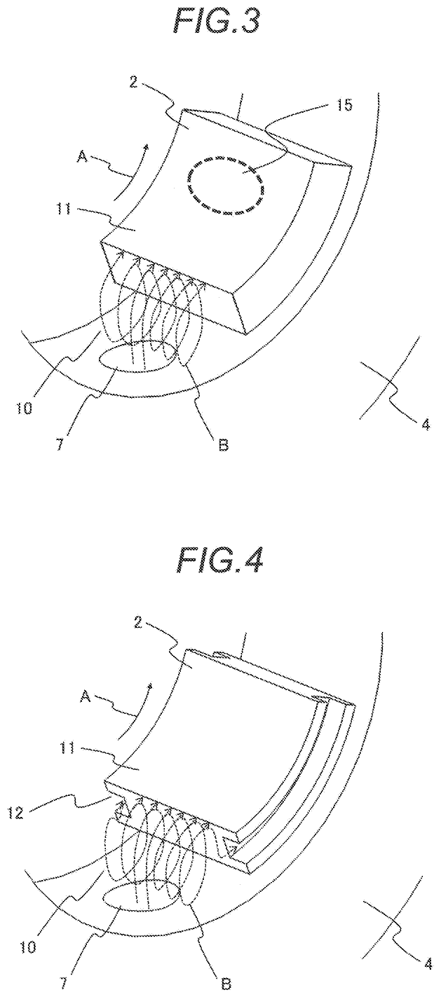

FIG. 3 is a perspective view of a commonly used tilting pad. Lubricant oil having flowed in the interior of the bearing though an oil feeding hole 7 swirls multiple times in the inter-pad spaces 10, as indicated by a lubricant oil flow B, and flows across the sliding surface 11. Thereby, the temperature of the oil in the space of the inter-pad space 10 decreases and low-temperature oil flows across the sliding surface 11. The temperature of the sliding surface 11 rises virtually linearly along the rotating direction A and a high-temperature portion 15 develops in a downward side. According to the examination made by the present inventors, to cool the high-temperature portion 15, it is more effective to decrease the temperature of oil that is supplied to the sliding surface than to cool the pad by disposing the cooling flow paths inside the pad. That is, the temperature of oil in the inter-pad spaces is important for decreasing the temperature of the sliding surfaces of the bearing. To decrease the temperature of oil in the inter-pad spaces, one method is to increase the oil feed amount, but it is necessary to expand the capacity of an auxiliary such as a pump. For this purpose, a bearing structure is desired that is capable of keeping the temperature of oil in the inter-pad spaces low and decreasing the temperature of the sliding surfaces of the bearing without changing the oil feed amount.

From this perspective, for the purpose of effective cooling of the high-temperature portion 15 of pad, it is required to provide a structure allowing oil in the inter-pad space to swirl enough to decrease the temperature of oil in the inter-pad space and decrease the temperature of oil that is supplied to the sliding surfaces, in addition to a structure for cooling the tilting pads themselves. And, such a structure is realized in the present invention as follows: a cooling flow path which is a circumferentially communicating path is disposed in a tilting pad and an arrangement is made so that an axial directional position of the cooling flow path inlet (its position in the axial direction with respect to the rotary shaft 1) is not coincident with an axial directional position of an oil feeding hole. By this structure, new oil with low temperature supplied through the oil feeding holes to the inter-pad space is prevented from flowing into the cooling flow path without swirling in the inter-pad space and the oil swirls multiple times, thus enabling it to decrease the temperature of oil in the inter-pad space. Oil in the inter-pad space, thus kept at low temperature, is supplied to the sliding surfaces and also supplied to the cooling flow path to cool the tilting pad itself. In this way, it is possible to decrease both the temperature of oil to be supplied to the sliding surfaces and the pad temperature and effectively cool the high-temperature portion 15 on sliding surface. It is also possible to suppress a rise in the temperature of the sliding surfaces of the bearing even at high rotating speed.

### Example 1

A first example of the present invention is described with FIG. 4. FIG. 4 is a perspective view of a tilting pad in the present example.

The present example is such that a cooling groove 12 which is a circumferentially communicating groove is disposed in a lateral face of a tilting pad 2 in an axial direction as a cooling flow path. The cooling groove 12 communicates with an inter-pad space 10 being upstream of the tilting pad 2 and an inter-pad space 10 being downstream thereof. Dimensions of the cross section of the cooling groove 12 should be set appropriately to increase the effect of cooling the tilting pad 2 through an experiment or the like. In addition, although the cooling groove 12 with a rectangular cross section of the flow path is depicted in FIG. 4, it is not limited to this. For example, it may be a cooling groove with a semi-circular cross section of the flow path. In addition, in FIG. 4, cooling grooves 12 are disposed in both side faces of the tilting pad 2 in the axial direction to make the effect of cooling the tilting pad 2 higher; nevertheless, a cooling groove 12 may be disposed only in one side face.

In the present example, the axial directional position of the inlet of the cooling groove 12 is not overlapped with the axial directional position of an oil feeding hole 7. Therefore, in the present example, lubricant oil having flowed into the inter-pad space 10 through the oil feeding hole 7 swirls multiple times, as is the case for the tilting pad depicted in FIG. 3, so that the temperature of oil in the inter-pad space decreases effectively. Then, oil with decreased temperature in the inter-pad space can be supplied to the sliding surface. Moreover, some of oil with its temperature decreased by swirling in the inter-pad space flows into the cooling groove 12, so that cooling the tilting pad 2 with high temperature is enabled. Thereby, it is possible to suppress a rise in the temperature of the sliding surfaces of the bearing even at high rotating speed.

To make oil supplied through the oil feeding hole 7 swirl effectively in the inter-pad space 10, it is important to make an arrangement so that the axial directional position of the inlet of the cooling flow path for cooling the pad is not coincident with the axial directional position of the oil feeding hole and new oil supplied into the inter-pad space 10 is prevented from flowing into the cooling flow path without swirling, as described previously. To accomplish this, although it is not necessary to dispose the cooling groove 12 in a side face of the tilting pad 2 in the axial direction as a cooling flow path, it is common that the oil feeding holes 7 are formed in a widthwise central portion of the bearing and forming the cooling groove 12 in either side of the tilting pad 2 is easier in terms of manufacturing (better in workability) than forming cooling holes inside the tilting pad 2 as cooling flow paths. Additionally, fatigue by stress concentration is less likely to occur and durability is better in comparison with a case of disposing the cooling groove 12 inside the tilting pad 2.

In addition, the structure of the tiling pad 2 depicted in FIG. 4 may apply to all tilting pads placed in a circumferential direction, as depicted in FIG. 1, whereas it may apply only to a tilting pad beneath the rotary shaft 1 and being subjected to a load. That is, because the clearance between the rotary shaft 1 and the tilting pad 2 beneath the shaft is the narrowest and heat generated by shear friction in the oil film adjacent to the tilting pad 2 beneath the shaft is the severest, decreasing the temperature of the tilting pad 2 and its vicinity by taking advantage of the structure of the present example makes it possible to suppress a rise in the temperature of the sliding surfaces of the bearing at high rotating speed within tolerance as the entire tilting pad bearing device.

### Example 2

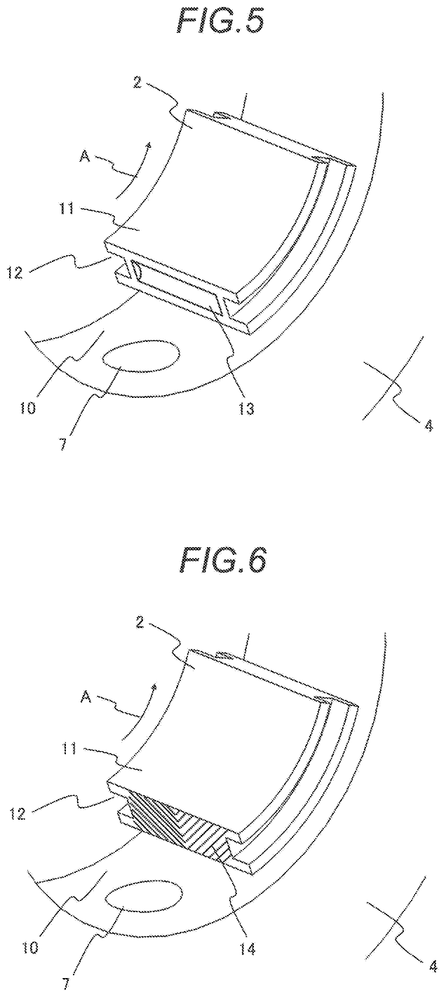

A second example of the present invention is described with FIG. 5. FIG. 5 is a perspective view of a tilting pad in the present example.

The present example is such that an arc-shaped groove 13 is disposed in a forward end (an upstream end in the rotating direction A) of a tilting pad 22 in addition to the structure of the first example. The arc-shaped groove 13 has an arc-shaped cross section as viewed from the axial direction and the center of the arc is positioned toward the oil feeding hole.

In the present example, lubricant oil having flowed into the inter-pad space 10 through the oil feeding holes 7 swirls along the arc-shaped groove 13 and, therefore, swirls more easily in the inter-pad space 10 than in the structure of the first example; this produces an effect of enabling it to sufficiently decrease the temperature of oil in the inter-pad space.

### Example 3

A third example of the present invention is described with FIG. 6. FIG. 6 is a perspective view of a tilting pad in the present example.

The present example is such that, in the forward end of the tilting pad 2, plural notches 14 cut diagonally are disposed from the sliding surface side to an axial directional center, symmetrically with respect to the axial directional center, in addition to the structure of the first example.

In the present embodiment, lubricant oil swirling in the inter-pad space 10 is allowed to flow along the notches 14 and toward the axial directional center and, therefore, swirls more easily in the inter-pad space 10 than in the structure of the first example. Additionally, although plural notches are disposed, the effect can be expected only by disposing at least one notch symmetrically with respect to the axial directional center.

### Example of Structure of Rotating Machine Applying Tilting Pad Bearing Device

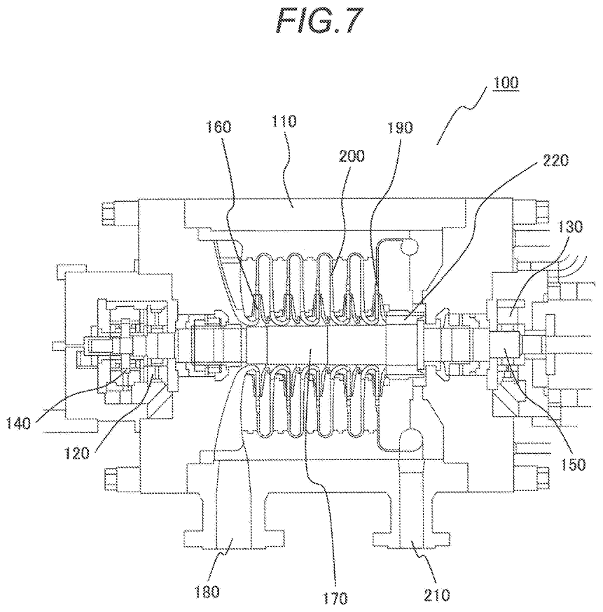

Then, an example of a structure of a rotating machine applying a tilting pad bearing device of the present invention is described with FIG. 7. FIG. 7 is a longitudinal sectional view depicting an overall structure of a centrifugal compressor which is one of typical turbo machines.

In FIG. 7, the centrifugal compressor 100 includes a casing 100 serving as a stationary part (stator) formed in a cylindrical shape or the like, a rotary shaft 150 disposed rotatably inside the casing 110, supported by radial bearings 120, 130, and a thrust bearing 140, and multiple stages (five stages in FIG. 7) of impellers 160 attached to the rotary shaft 150. The rotary shaft 150 and the impellers 160 constitute a rotor 170. Additionally, in the present example, the description takes up as an example the centrifugal compressor of a single-shaft, multiple-stage type in which multiple stages of impellers 160 are disposed on one rotary shaft 150; however, application is also possible for a single-stage centrifugal compressor with only one stage of an impeller 160 in the same way.

In the casing 110, inter alia, the following are disposed: an intake flow path 180 which introduces gas which is working fluid to a first stage impeller 160, a diffuser 190 which coverts kinetic energy of gas emitted from each stage impeller 160 to pressure energy, a return flow path 200 which introduces compressed gas from the diffuser 190 to a next stage impeller 160, and an ejecting flow path 210 which ejects gas emitted from a last stage impeller 160 out of the casing 110.

The rotary shaft 150 of the rotor 170 is rotatably supported via the radial bearings 120, 130 disposed in an intake side end (left in FIG. 7) and an ejection side end (right in FIG. 7) of the casing 110. Also, the thrust bearing 140 which is subjected to a thrust load is disposed in the intake side end of the rotary shaft 150 and a balancing piston 220 which balances out the thrust load is disposed in the ejection side of the last stage impeller 160 in the rotary shaft 150.

A driving machine (omitted from depiction) such as a motor is coupled to the ejection side end of the rotary shaft 150, and the rotor 170 is driven to rotate by the driving machine. Also, an arrangement is made such that the rotation of the rotor 170 causes gas to be drawn in through the intake flow path 180, compressed in turn by the multiple stages of impellers 160, and finally ejected through the ejecting flow path 210.

In the structure described above, tilting pad bearing devices of the present invention are used for the radial bearings 120, 130. To downsize and speed up the centrifugal compressor, it is required to increase the peripheral speed of the bearings. Along with an increase in the peripheral speed of the bearings, the bearing temperature rises and this poses an increased risk of damaging the bearings. By using the tilting pad bearing devices of the present invention as the radial bearings 120, 130, it is possible to realize downsizing and speeding up the centrifugal compressor, suppressing a rise in the bearing temperature.

Now, the present invention is not limited to the embodiments described hereinbefore, and various modifications are included therein. For example, the foregoing embodiments are those described in detail to explain the present invention clearly and the present invention is not necessarily limited to those including all components described. In addition, a subset of the components of an embodiment may be replaced by components of another embodiment and components of another embodiment may be added to the components of an embodiment. In addition, for a subset of the components of each embodiment, other components may be added to the subset or the subset may be removed or replaced by other components.

### REFERENCE SIGNS LIST

1 . . . rotary shaft, 2 . . . tilting pad, 3 . . . pivot, 4 . . . bearing housing, 5 . . . bearing casing, 6 . . . oil guide groove, 7 . . . oil feeding hole, 8 . . . oil guide hole, 9 . . . sealing, 10 . . . inter-pad space, 11 . . . sliding surface, 12 . . . cooling groove, 13 . . . groove, 14 . . . notch, 15 . . . high-temperature portion, A . . . rotating direction, B . . . lubricant oil flow, 100 . . . centrifugal compressor, 110 . . . casing, 120, 130 . . . radial bearing, 140 . . . thrust bearing, 150 . . . rotary shaft, 160 . . . impeller, 170 . . . rotor, 180 . . . intake flow path, 190 . . . diffuser, 200 . . . return flow path, 210 . . . ejecting flow path, 220 . . . balancing piston.

1. A tilting pad bearing device,
wherein the tilting pad bearing device is an oil bath type tilting pad bearing device;
a tilting pad beneath a rotary shaft supported by the tilting pad bearing device is provided with a cooling flow path which is a circumferentially communicating path; and
the cooling flow path is disposed so that an axial directional position of its inlet is not coincident with an axial directional position of a hole for feeding oil to a space between tilting pads.

2. A tilting pad bearing device comprising: a bearing housing; a plurality of tilting pads, each of which is swingably disposed on the inside of the bearing housing via a pivot and supports a rotary shaft; and sealings disposed on both sides of the bearing housing in an axial direction,
wherein at least one of the tilting pads beneath the rotary shaft is provided with a cooling flow path which is a circumferentially communicating path in a side face thereof in an axial direction.

3. The tilting pad bearing device according to claim 1,
wherein the tilting pad is provided with a groove having an arc-shaped cross section as viewed from an axial direction in an upstream end thereof in a circumferential direction, as viewed from a rotating direction of the rotary shaft.

4. The tilting pad bearing device according to claim 1,
wherein the tilting pad is provided with a notch formed diagonally from a sliding surface side to an axial directional center, symmetrically with respect to the axial directional center in an upstream end thereof in a circumferential direction, as viewed from the rotating direction of the rotary shaft.

5. A rotating machine comprising: a rotary shaft; and a radial bearing which supports the rotary shaft,
wherein a tiling pad bearing device described in claim 1 is used as the radial bearing.

6. The tilting pad bearing device according to claim 2,
wherein the at least one of the tilting pads is provided with a groove having an arc-shaped cross section as viewed from an axial direction in an upstream end thereof in a circumferential direction, as viewed from a rotating direction of the rotary shaft.

7. The tilting pad bearing device according to claim 2,
wherein the at least one of the tilting pads is provided with a notch formed diagonally from a sliding surface side to an axial directional center, symmetrically with respect to the axial directional center in an upstream end thereof in a circumferential direction, as viewed from the rotating direction of the rotary shaft.

8. A rotating machine comprising: a rotary shaft; and a radial bearing which supports the rotary shaft,
wherein a tiling pad bearing device described in claim 2 is used as the radial bearing.
